(19) United States
(12) Patent Application Publication
(10) Pub. No.: US 2007/0001842 A1
(43) Pub. Date: Jan. 4, 2007

(54) Method and means for providing security

(76) Inventor: Leslie Smiedt, Green Point (ZA)

Correspondence Address: STITES & HARBISON PLLC, 1199 NORTH FAIRFAX STREET, SUITE 900, ALEXANDRIA, VA, 22314, US

(21) Appl. No.: 10/548,061

(22) PCT Filed: Mar. 8, 2004
(86) PCT No.: PCT/ZA04/00024

§ 371 Date: Aug. 22, 2006

(30) Foreign Application Priority Data
Mar. 6, 2003 (ZA) 2003/1835

(51) Int. Cl. G08B 1/08; H04Q 7/00

(52) U.S. Cl. 340/539.14

(57) ABSTRACT

the present invention provides a method of detecting that a shipping container has been tampered with by unlawful opening of its doors, and a method of ensuring that patrolmen on duty are both safe and are patrolling their appointed route. Tags which are activated to transmit a signal as a result of an activating unit being brought into proximity thereto, or separated therefrom, are used. In protecting a shipping container the tag forms part of a detector structure which stores and transmits data which data changes when the container doors are opened and closed. In protecting premises, the patrolman activates each tag as he passes it to cause signals to be transmitted back to a control room. This indicates that the patrolman is moving from tag to tag in accordance with his schedule.

### FIELD OF THE INVENTION

THIS INVENTION relates to a method of and means for providing security.

### BACKGROUND TO THE INVENTION

In the face of increasingly sophisticated acts of terrorism, those charged with providing security must endeavour to locate vulnerable security areas, and strengthen those areas before terrorists identify an opportunity for an act of destruction. Ships, and in particular the shipping containers they carry, have been identified as a potential risk area.

Some authorities have concluded that containerization has resulted in there being in the order of 14 million shipping containers throughout the world. The essence of containerization is that the shipping container is packed and locked shut at the point from which the goods are shipped and is not opened again until it reaches its destination. Major ports handle many hundreds of thousands of containers annually. The volume of containers being moved is such that only a very small percentage is inspected.

This has been recognised by certain authorities as posing a terrorist threat. The scenario they postulate is that somewhere between where the container is closed and the point at which the container is opened lawfully, the container will be opened unlawfully, biological, chemical or other weapons will be secreted in the container, and the container will be re-closed. The intended purpose would be to release the weapons in an area where there is a population, and a further purpose would be to disrupt commercial activities.

The present invention provides, according to one of its aspects, a method of determining that unlawful tampering with a shipping container has taken place.

Buildings and building complexes, particularly research establishments having sensitive materials in them, are also targets for terrorist activity. Such establishments have sophisticated security systems. Even with such systems patrols are still considered essential and the patrolmen move around the complex checking for signs of illegal activity.

A question which of necessity arises is whether the patrolmen are in fact patrolling as required or whether, during quiet periods, the patrols diminish in frequency or are discontinued altogether. This has to be monitored if the system is going to fulfill its primary objective.

A further requirement of an adequate patrol monitoring system is that those in the control room should be aware of the progress of the patrolman around the premises. It is not acceptable for a patrol man to leave the control room and reappear at a later time without any intervening information on what he did.

If current systems of monitoring patrol activities are considered, the way in which they fall short of meeting the requirements set out above will be understood.

In the simplest possible system the patrolman leaves the guard house and returns at a later time. There is no record of where he went or whether he completed his round. Also, there is no way of knowing if he has encountered an intruder and been rendered ineffective until he fails to return at the correct time. The time delay inherent in such a system is not acceptable as it leaves an intruder with freedom to move about for a period of time without the alarm being raised.

To ensure that the patrolman does complete his round, a simple known system comprises a series of boxes along the patrol route. Each box contains the key to the next box on the round. Only by opening each box in turn and retrieving the key in it can the patrolman obtain the last key in the sequence which indicates completion of the round. The system is deficient in that it fails to detect a problem in “real time”. Until the patrolman's return time has passed and he has failed to come back, there is nothing to indicate that there is a problem.

In other systems there are tags along the route and the patrolman has a reader in his possession. By bringing the reader into close proximity with a tag, details of the tag are recorded on the reader. The information on the reader is downloaded when the patrolman returns thereby, at least theoretically, indicating completion of a full round. In practice, it is possible for the tags to be collected on the first patrol and returned on the last. Intermediate patrols, without leaving the control house, record on their readers from the collected tags the information which should be there to show a completed patrol. Even if implemented properly, this system again suffers from the time lapse problem discussed above.

In another of its aspects the present invention provides a method of and means for ascertaining details of the patrols undertaken by the patrolmen on duty.

### BRIEF DESCRIPTION OF THE INVENTION

According to one aspect of the present invention there is provided a method of enhancing security which method comprises distributing tags throughout an area to be protected, each tag transmitting an identification signal, bringing a tag reader into said area, the reader picking up the signals transmitted by the tags, and downloading from the reader to a remote location the signals picked up by the reader from the tags.

The signal transmitted by the tag is preferably a radio frequency signal. Likewise it is preferred that the reader transmit at radio frequency.

The signal transmitted by each tag can include data indicative of the status of the tag.

In a specific form, the status indicating data transmitted is compared with stored data and a determination made as to whether there has been a change in the status of the tag. In a further form the reader is carried by a patrolman patrolling said area, the signal from each tag which the patrolman passes being picked up by the reader and transmitted to said remote location whereby the progress of the patrolman is tracked.

Said area can be one having shipping containers therein and the tags can be fitted to the containers, said data changing upon a door of the container to which the tag is fitted being opened whereby unauthorized door opening can be detected when the signal from that tag is read.

According to a further aspect of the present invention there is provided a method of determining whether a door of a shipping container has been opened, the method comprising applying a tag to one component of a shipping container, there being a tag operating means which moves with another component of the shipping container, said components being ones that move relatively to one another during opening of said door of the container, storing a signal on said tag as said components move together on door closing, changing said stored signal upon said tag and its operating means being separated during door opening, downloading the signal stored in the tag at the time the door is lawfully closed, and accessing said stored signal on the tag before the door is lawfully opened to verify that said signal has not changed due to unlawful door opening.

The method can include the further step of applying a tag operating device to the other component of the container.

The invention can comprise the steps of fitting said tag or device to a handle constituting said one of said components, said handle being moved to unlock the container, and fitting the device or tag to a further component with respect to which said one component moves during opening.

In another form of the method of the present invention said tag and device are fitted one to said door and one to the frame of the container so that the device and tag are separated as the container door is opened.

To enable continuous monitoring to take place, the method also includes the step of transmitting, at timed intervals and at radio frequency, the signal stored in the tag. The method can comprise storing a unique tag identification signal in the tag, and transmitting, at timed intervals and a radio frequency, the unique identification signal stored in the tag.

According to another aspect of the invention there is provided a method of monitoring a patrolman's progress which method comprises distributing tags along the patrolman's route, each tag transmitting a unique identification signal, providing the patrolman with a reader for receiving said identification signals upon any of the tags and said reader being brought into sufficiently close proximity, and transmitting the tag identification signals picked up by the reader to a control room thereby to permit the patrolman's progress from tag-to-tag to be monitored.

### BRIEF DESCRIPTION OF THE DRAWINGS

For a better understanding of the present invention, and to show how the same may be carried into effect, reference will now be made, by way of example, to the accompanying drawings in which:

FIG. 1 is a diagrammatic pictorial view of one end portion of a shipping container; and

FIG. 2 is a diagrammatic plan view of a complex of buildings.

### DETAILED DESCRIPTION OF THE INVENTION

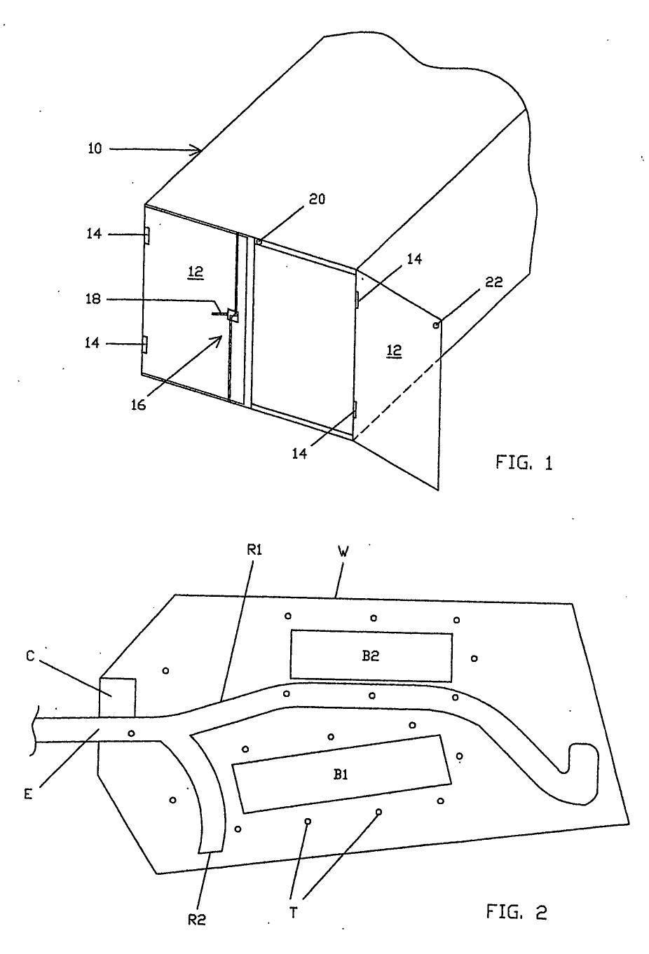

Referring firstly to FIG. 1, reference numeral 10 designates a shipping container the double doors 12 of which permit access to be had to the interior of the container. The doors 12 are hinged at 14 along their outer edges and one is shown open. A door locking mechanism is shown at 16 this including an operating handle 18 which is used to displace locking bolts. The handle 18 is secured by a tamper evident sealing structure after the container has been loaded.

A tag is shown at 20, the tag being secured to the framework of the container so that it is hidden when the doors 12 are closed. A tag operating device is shown at 22, this being fitted to the door. Alternatively, the tag can be fitted to the handle 18 and the operating device to the door 12 close to the handle. The tag and device are separated sufficiently, on the handle being displaced from the locked position to the unlocked position, to operate the tag.

Suitable tags 20 are available from Wavetrend UK Ltd and technical information can be found on their website at www.wavetrend.net.

The tags include radio frequency transmitters and their own internal power source. They each have a unique identification number which is transmitted continuously after tag activation. Tag activation occurs at the end of the manufacturing procedure. The tag transmits the unique identification number at predetermined intervals. The interval can be very short and can be a few milliseconds. The range of the transmitter is a few meters.

In addition to the unique identification number the tag also has a further number which is incremented each time the tag and the operating device are brought into operating relationship. By way of example, the tag can include a magnetically operated switch such as a reed switch and the operating device can include a magnet.

In addition to transmitting the unique number, the tag transmits the subsisting incremented number.

In accordance with the present invention the tag and the tag operating device are, as described above, fitted to any two components of the shipping container which components move relatively to one another as the door 12 of the container is opened.

To transfer information to a controlling computer it is possible to use a hand held reader which is brought into proximity with the tag and then download the information on the reader to the computer. For example, the stored number and the unique number can be transmitted at radio frequency via satellite or other communication system from the reader to the controlling computer.

On arrival of the container at its destination, the tag is scanned, the stored unique and incremented numbers downloaded, and a comparison made between the downloaded incremented number and the incremented number stored in the controlling computer. If they match the container has not been unlawfully opened. If they do not match then the door has been opened in transit.

As described, both the stored numbers are transmitted at predetermined intervals by the tag, these transmissions being received by the readers and stored in a computer onboard the ship. At intervals the received numbers can be transmitted via a satellite link to the controlling computer for comparison with the stored numbers. Thus an early warning that tampering has occurred can be obtained.

A practical way in which the system can be implemented will now be described.

The ship's cargo manifest records the numbers of all shipping containers which are to be loaded at a specific port. This information is transmitted, once the list of the shipping containers to be loaded has been finalized, to the controlling computer. As the tag applied to a container will be permanently on that container (except in the event of damage) the controlling computer can correlate the tag identification with the container number. Those responsible for ensuring that the cargo is correctly loaded, and checked, are provided with hand held readers. Such readers comprise the tag reader itself plus a transceiver which enables data to be received and sent.

The ship has an identity code. When the operator enters this in his reader and transmits, there is a download of full details of the containers to be loaded.

The tags on the containers all transmit their “incremental number”. This number was re-set when the container was last opened and again when it was last closed. The incremental numbers on the tags are not at this time known. By setting the reader to the appropriate mode, the incremental numbers being transmitted by the tags listed for loading on that ship are picked-up and stored in the reader against the tag number and the shipping container number.

Once all the incremental numbers have been logged, the reader transmits the container numbers, the tag numbers and the incremental numbers back to the controlling computer. It will be appreciated that if an incremental number is not recorded against a tag, then the related container has not been loaded, or possibly its tag is malfunctioning.

Opening of a container causes the incremental number to change. This change can be detected when the tags of containers on board the ship are scanned. Scanning is preferably at intervals during the voyage but can be as the vessel approaches a port.

Turning now to FIG. 2, this diagrammatically illustrates a complex comprising a boundary wall W, a control room C at the entrance E to the complex, and a plurality of tags T distributed through the complex and along the routes that the patrolmen have to follow. The buildings in the complex are designated B1, B2 etc. and the road system R1, R2 etc. The tags T are as described above except in that they do not require numbers that can be incremented.

The patrolman carries a tag reader which, when in the proximity of a tag, receives the unique number transmitted by the tag. The readers transmit a signal to the control room indicating that the tag has been read. At the control room C there is a receiver for detecting signals transmitted by the reader.

It will be understood that, in real time, those in the control room can follow the progress of the patrolman from tag to tag as the reader picks up the signal from each tag. In the event that an expected reading from a subsequent tag in a sequence is not received, the controller becomes aware, after a minimal time lapse, that there is a circumstance which requires investigation.

1. A method of enhancing security which comprises distributing tags throughout an area to be protected, each tag transmitting an identification signal, bringing a tag reader into said area, the reader picking up the signals transmitted by the tags, and downloading from the reader to a remote location the signals picked up by the reader from the tags.

2. A method as claimed in claim 1, wherein the tags transmit their identification signals at radio frequency.

3. A method as claimed in claim 1, wherein the reader transmits to the remote location at radio frequency.

4. A method as claimed in claim 1, wherein the signal transmitted by each tag includes data indicative of the status of the tag.

5. A method as claimed in claim 4, wherein the status indicating data transmitted is compared with stored data and a determination made as to whether there has been a change in the status of the tag.

6. A method as claimed in claim 1, wherein the reader is carried by a patrolman patrolling said area, the signal from each tag which the patrolman passes being picked up by the reader and transmitted to said remote location whereby the progress of the patrolman is tracked.

7. A method as claimed in claim 4, wherein said area is one having shipping containers therein and the tags are fitted to the containers, said data changing upon a door of the container to which the tag is fitted being opened whereby unauthorized door opening can be detected when the signal from that tag is read.

8. A method of determining whether a door of a shipping container has been opened, the method comprising applying a tag to one component of a shipping container, there being a tag operating means which moves with another component of the shipping container, said components being ones that move relatively to one another during opening of said door of the container, storing a signal on said tag as said components move together on door closing, changing said stored signal upon said tag and its operating means being separated during door opening, downloading the signal stored in the tag at the time the door is lawfully closed, and accessing said stored signal on the tag before the door is lawfully opened to verify that said signal has not changed due to unlawful door opening.

9. A method as claimed in claim 8 and including the step of applying a tag operating device to the other component of the container.

10. A method as claimed in claim 9 and which comprises the steps of fitting said tag or device to a handle constituting said one of said components, said handle being moved to unlock the container, and fitting the device or tag to a further component with respect to which said one component moves during opening.

11. A method as claimed in claim 9, wherein said tag and device are fitted one to said door and one to the frame of the container so that the device and tag are separated as the container door is opened.

12. A method as claimed in claim 8 and including the step of transmitting, at timed intervals and at radio frequency, the signal stored in the tag.

13. A method as claimed in claim 12, and including the further step of storing a unique tag identification signal in the tag, and transmitting, at timed intervals and a radio frequency, the unique identification signal stored in the tag.

14. A method of monitoring a patrolman's progress which method comprises distributing tags along the patrolman's route, each tag transmitting a unique identification signal, providing the patrolman with a reader for receiving said identification signals upon any of the tags and said reader being brought into sufficiently close proximity, and transmitting the tag identification signals picked up by the reader to a control room thereby to permit the patrolman's progress from tag-to-tag to be monitored.
